(19) United States
(12) Patent Application Publication
(10) Pub. No.: US 2023/0259929 A1
(43) Pub. Date: Aug. 17, 2023

(54) BLOCKCHAIN BASED IDENTITY MANAGEMENT FOR A SUPPLY CHAIN OF A COMPUTERISED NETWORK

(71) Applicants: NewSouth Innovations Pty Limited, Sydney, New South Wales (AU); The University of Sydney, Sydney, New South Wales (AU)

(72) Inventors: Abubakar Sadiq Sani, Sydney, (AU); Zhao Yang Dong, Sydney, (AU); Ke Meng, Sydney, (AU); Dong Yuan, Sydney, (AU)

(21) Appl. No.: 18/007,065

(22) PCT Filed: Jul. 30, 2021
(86) PCT No.: PCT/AU2021/050835

§ 371 Date: Jan. 27, 2023

(30) Foreign Application Priority Data
Jul. 31, 2020 (AU) 2020902698

(51) Int. Cl. G06Q 20/38; G06Q 20/40; G06Q 20/30; H04L 9/32; H04L 9/00; H04L 9/30

(52) U.S. Cl. CPC G06Q 20/389; G06Q 20/4014; G06Q 20/3825; G06Q 20/3829; G06Q 20/308; H04L 9/3247; H04L 9/50; H04L 9/3066

(57) ABSTRACT

Disclosed is a computer implemented method, system and computer readable medium for performing blockchain-based identity management for a supply chain of a computerised network. In one aspect, the method includes receiving, by a computerised device of a party, an identity issuing transaction initiated by a computerised component or service being in the supply chain, the identity issuing transaction being indicative of a name of the computerised component or service, an identity issuing request message, and a first random number obtained from a distributed database, wherein the identity issuing transaction is initiated by the computerised component or service in response to determining the party is an authoritative party recorded in the blockchain and permitted to issue an identity, invoking a first smart contract, and executing an identity issuance logic of the first smart contract.

### RELATED APPLICATIONS

The present application claims priority from Australian Provisional Patent Application No. 2020902698, filed 31 Jul. 2020, the contents of which is herein incorporated by reference in its entirety.

### TECHNICAL FIELD

The present invention relates generally to an identity management system, method and computer readable medium for a supply chain of a computerised network, and in particular to an Internet of Things (IoT) network.

### BACKGROUND

Supply chain attacks such as forged certificates and modified software updates to a computerised network, such as an Internet of Things (IoT) network (e.g. a smart grid) remain a major challenge. These attacks, which focus on compromising computerised components and services of the network, can have a cascading effect on operations of the computerised network. A large number of interdependencies between the components and services and reliance on trusted third parties hinders the ability to safely and securely identify and authenticate the components and services.

### SUMMARY

It is an object of the present invention to substantially overcome, or at least ameliorate, one or more disadvantages of existing arrangements or provide a useful alternative.

In a first aspect, the present disclosure provides a computer implemented method of performing blockchain-based identity management for a supply chain of a computerised network, wherein the method includes: receiving, by a computerised device of a party, an identity issuing transaction initiated by a computerised component or service in the supply chain, the identity issuing transaction being indicative of a name of the computerised component or service, an identity issuing request message, and a first random number obtained from a distributed database, wherein the identity issuing transaction is initiated by the computerised component or service in response to determining the party is an authoritative party recorded in the blockchain and permitted to issue an identity; invoking a first smart contract; executing an identity issuance logic of the first smart contract to: determine whether the computerised component or service has been recorded in the blockchain, and the computerised component or service has not been issued an identity; and generate, in response to a positive determination, an identity for the computerised component or service based on the name of the component or service, the identity issuing request message, the first random number and a digital signature algorithm; storing first transaction data associated with executing the identity issuance logic of the first smart contract on the blockchain which is broadcast to the computerised network; and transferring, to the computerised component or service, the generated identity for use in authenticating the computerised component or service in the supply chain of the computerised network.

In certain implementations, the digital signature algorithm uses a private key of the authoritative party to generate the identity of the computerised component or service, wherein the identity is a digitally signed identifier using the private key.

In certain implementations, the method further includes: receiving, by the computerised device of the party, an attribute identifier issuing transaction initiated by the computerised component or service after being issued with the identity, the attribute identifier issuing transaction being indicative of the identity of the computerised component or service, an attribute identifier request message, and a second random number obtained from the distributed database, wherein the attribute identifier issuing transaction is initiated by the computerised component or service in response to determining the party is the authoritative party recorded in the blockchain and permitted to issue an attribute identifier; invoking a second smart contract; executing an attribute identifier issuance logic of the second smart contract to: determine whether the identity of the computerised component or service is recorded in the blockchain and whether no revocation of the identity of the computerised component or service is recorded in the blockchain; generate, in response to a positive determination, the attribute identifier for the attribute of the computerised component or service based on the attribute identifier request message, the second random number and a digital signature algorithm; storing second transaction data associated with executing the attribute identifier issuance logic of the second smart contract on the blockchain which is broadcast to the computerised network; and transferring, to the computerised component or service, the generated attribute identifier for use in authenticating the attribute of the computerised component or service in the supply chain of the computerised network.

In certain implementations, generating the attribute identifier for the attribute of the computerised component or service is further based on a pseudo-random function which is dependent upon the second random number and the identity of the computerised component or service.

In certain implementations, the digital signature algorithm uses the private key of the authoritative party to generate the attribute identifier of the attribute of the computerised component or service, wherein the attribute identifier is a digitally signed attribute identifier using the private key.

In certain implementations, the method further includes: invoking a third smart contract to authenticate identification data including one of the identity of the computerised component or service or the attribute identifier of the computerised component or service; executing an identification data check logic of the third smart contract to verify if the identification data is authentic; storing, in response to the identification data being verified as authentic, third transaction data associated with executing the identification data check logic of the third smart contract on the blockchain which is broadcast to the computerised network.

In certain implementations, the digital signature algorithm uses a public key corresponding to the private key of the authoritative party to verify if the identification data is authentic.

In certain implementations, the digital signature algorithm is Elliptic Curve Digital Signature Algorithm (ECDSA).

In certain implementations, the method further includes storing revocation transaction data on the blockchain which is broadcast to the computerised network in response to determining that the computerised component or service has violated the first smart contract, wherein the revocation transaction data is indicative of the revocation of the identity of the computerised component or service.

In certain implementations, the method includes using Transport Layer Security (TLS) to establish a secure communication channel for data exchange.

In certain implementations, the method includes using a key agreement protocol based on or including Elliptic-curve Diffie-Hellman (ECDH) to establish a secure communication channel for data exchange.

In certain implementations, the computerised network is an Internet of Things (IoT) network.

In certain implementations, the IoT network is a smart grid network.

In a second aspect, the present disclosure provides a computer implemented system including one or more memories having stored therein computer executable instructions, and one or more processors configured to execute the computer executable instructions to cause the computer implemented system to implement the computer implemented method of the first aspect and/or the implementations thereof.

In a third aspect, the present disclosure provides more computer readable storage mediums having stored therein computer executable instructions for configuring a computer implemented system having one or more processors, wherein execution of the computer executable instructions by the one or more processors configure the computer implemented system to perform the method of the first aspect and/or the implementations thereof.

Other aspects are also disclosed.

### BRIEF DESCRIPTION OF THE DRAWINGS

Example embodiments should become apparent from the following description, which is given by way of example only, of at least one preferred but non-limiting embodiment, described in connection with the accompanying figures.

FIG. 1 is a system diagram of an example of a computerised network according to the present disclosure.

FIG. 2 is a schematic illustrating an example blockchain structure for performing identity management according to the present disclosure.

FIG. 3 is a flow diagram representing a method of performing identity management for a computerised network according to the present disclosure.

FIGS. 4A and 4B form a schematic block diagram of a general purpose computer system upon which arrangements described can be practiced.

FIGS. 5A and 5B collectively form a schematic block diagram representation of an electronic device upon which described arrangements can be practised.

FIG. 6A is a flow diagram representing a method of issuing an identity to a component or service.

FIG. 6B is a flow diagram representing a method of a smart grid analytics technologies company issuing an identity to a smart grid temperature sensor.

FIG. 7A is a flow diagram representing a method of issuing an identity for an attribute of a component or service.

FIGS. 7B and 7C is a flow diagram representing a method of issuing using an identity for a firmware of a smart grid actuator.

FIG. 8A is a flow diagram representing a method of authenticating an identity of a component or service, or an attribute of a component or service.

FIG. 8B is a flow diagram representing a method of a smart grid analytics technologies company authenticates a temperature sensor identity of a temperature sensor of a smart grid.

FIG. 9A is a flow diagram representing an example of a malicious attack to a computerised network.

FIGS. 9B and 9C is a flow diagram representing an example of mitigating the malicious attack described in relation to FIG. 9A using the identity management system and method according to the present disclosure.

FIGS. 10A and 10B show example user interfaces presented via an authoritative party computerised device for implementing identity management according to the present disclosure.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

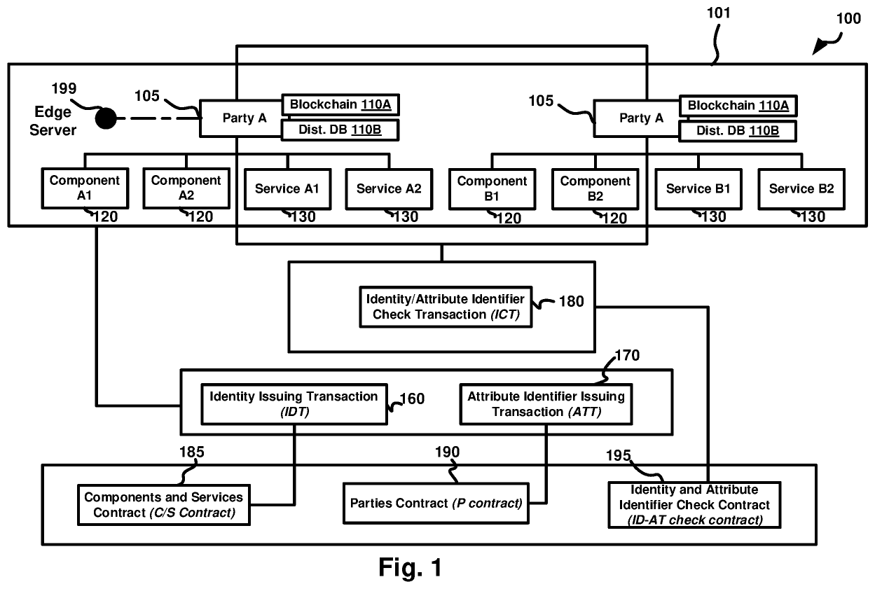

Referring to FIG. 1 there is shown a system diagram representing a computerised system 100 for performing blockchain-based identity management for a supply chain of a computerised network. In FIG. 1, the computerised system 100 includes a computerised network 101 including a first party computerised device 105 associated with a first party and a second party computerised device 105 associated with a second party. In an example of a smart grid, the parties 105 may be generation companies (GENCOs), distribution companies (DISCOs), transmission companies (TRANSCOs), and service providers. These parties 105 are referred to as authoritative parties or ‘genuine parties’ of the computerised network 101. The first party computerised device and second party computerised device 105 include adequate computational and storage resources. With this in mind, throughout the description, the first party computerised device and second party computerised device 105 may be referred to as simply a ‘party’. The party can obtain a public and private key pair via a Public Key Infrastructure (PKI). The public and private key pair are stored in the respective party's secure storage medium, such as a (crypto) wallet and used for executing cryptographic algorithms in the computerised system.

As shown in FIG. 1, the computerised network 101 also includes one or more computerised components 120 representing computerised devices owned by authoritative parties 105 of the computerised network 101 such as a smart grid. One or more components of the network 101 may perform one or more computerised services 130 representing one or more actions such as essential services that assist with deploying the one or more components in the computerised network 101. Each computerised component or service 120, 130 has one or more unique attributes that can be used in identifying the respective computerised component or service 120, 130 to optimise operational efficiencies in the computerised network 101.

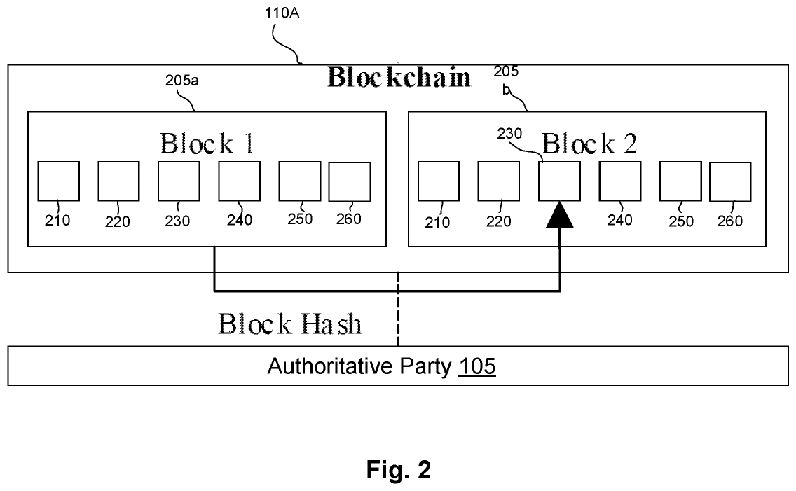

As shown in FIG. 1, the computerised system 100 further includes a blockchain 110A and a distributed database 110B. A more detailed schematic of the blockchain 110A is shown in FIG. 2. The blockchain 110A is used for data verification and keeping track and record of transactions. The transactions are chained together and stored in blocks, each of which includes the following elements: an index 210 representing the position of the current block on the blockchain; a transaction hash 220 representing the hash of a transaction; a block hash 230 representing the hash that chains a block to its predecessor; a block number 240 representing the position of the block; data 250 representing the transaction data; and a transaction topic 260 representing the topic of the transaction by a component or service 120, 130. As shown in FIG. 2, an authoritative party computerised device 105 collects transactions into block 205a. Once the block is full, i.e. the size of data in the block reaches 1 MB, the block hash is appended to Block 205b. In the present disclosure, transactions associated with any computerised component or service 120, 130, such as an IoT component like a smart grid component or service, can be executed by one of the authoritative party computerised devices 105, which use the blockchain 110A for storing data.

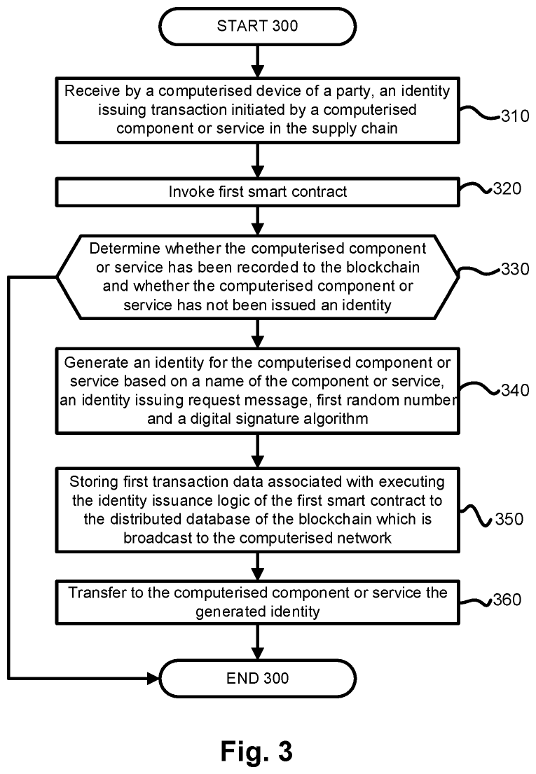

Referring to FIG. 3 there is shown a flowchart representing a method 300 for performing blockchain-based identity management for a supply chain of a computerised network. The flowchart will be described with reference to the computerised system exemplified in FIG. 1.

At step 310, the method 300 includes receiving, by a computerised device of a party, an identity issuing transaction 160 initiated by a computerised component or service in the supply chain. The identity issuing transaction is indicative of a name of the computerised component or service, an identity issuing request message, and a first random number obtained from a distributed database. The identity issuing transaction 160 is initiated by the computerised component or service in response to determining the party is an authoritative party recorded in the blockchain and permitted to issue an identity.

At step 320, the method 300 includes invoking a first smart contract 185.

At step 330, the method 300 includes executing an identity issuance logic of the first smart contract 185 to determine whether the computerised component or service has been recorded in the blockchain, and the computerised component or service has not been issued an identity. In response to a positive determination (i.e. both conditions being answered positively), the method continues to step 340.

At step 340, the method 300 includes generate, in response to a positive determination and the execution of the identity issuance logic, an identity for the computerised component or service based on the name of the component or service, the identity issuing request message, the first random number and a digital signature algorithm.

At step 350, the method 300 includes storing first transaction data associated with executing the identity issuance logic of the first smart contract 185 on the blockchain which is broadcast to the computerised network.

At step 360, the method 300 includes transferring, to the computerised component or service, the generated identity for use in authenticating the computerised component or service in the supply chain of the computerised network.

The digital signature algorithm can use a private key of the authoritative party to generate the identity of the computerised component or service 120, 130, wherein the identity is a digitally signed identifier using the private key.

In further implementations, the method further includes receiving, by the computerised device of the party, an attribute identifier issuing transaction 170 (see FIG. 1) initiated by the computerised component or service after being issued with the identity. The attribute identifier issuing transaction 170 can be indicative of the identity of the computerised component or service, an attribute identifier request message, and a second random number obtained from the distributed database. The attribute identifier issuing transaction 170 is initiated by the computerised component or service in response to determining the party is the authoritative party recorded in the blockchain and permitted to issue an attribute identifier.

After the attribute identifier issuing transaction 170 is initiated, a second smart contract 190 can be invoked. The method then includes executing an attribute identifier issuance logic of the second smart contract 190 to determine whether the identity of the computerised component or service is recorded in the blockchain and whether no revocation of the identity of the computerised component or service is recorded in the blockchain.

In response to a positive determination, the method includes generating the attribute identifier for the attribute of the computerised component or service based on the attribute identifier request message, the second random number and a digital signature algorithm. Second transaction data associated with executing the attribute identifier issuance logic of the second smart contract 190 can be stored on the blockchain which is broadcast to the computerised network. The generated attribute identifier can be transferred to the computerised component or service for use in authenticating the attribute of the computerised component or service in the supply chain of the computerised network.

In further implementations of the method, a third smart contract 195 can be invoked to authenticate identification data including one of the identity of the computerised component or service or the attribute identifier of the computerised component or service. Identification data check logic of the third smart contract 195 is executed to verify if the identification data is authentic. In response to the identification data being verified as authentic, third transaction data associated with executing the identification data check logic of the third smart contract 195 can be stored on the blockchain which is broadcast to the computerised network.

In certain implementations, generating the attribute identifier for the attribute of the computerised component or service is further based on a pseudo-random function which is dependent upon the second random number and the identity of the computerised component or service.

In certain implementations, the digital signature algorithm uses the private key of the authoritative party to generate the attribute identifier of the attribute of the computerised component or service, wherein the attribute identifier is a digitally signed attribute identifier using the private key. The digital signature algorithm can use a public key corresponding to the private key of the authoritative party to verify if the identification data is authentic. The digital signature algorithm can be Elliptic Curve Digital Signature Algorithm (ECDSA).

In some instances, the method further includes storing revocation transaction data on the blockchain which is broadcast to the computerised network in response to determining that the computerised component or service has violated the first smart contract 185. The revocation transaction data is indicative of the revocation of the identity of the computerised component or service.

In certain implementations, the method includes using Transport Layer Security (TLS) to establish a secure communication channel for data exchange. In other instances, the method includes using a key agreement protocol based on or including Elliptic-curve Diffie-Hellman (ECDH) to establish a secure communication channel for data exchange.

As shown in FIG. 1, the computerised system 100 can include an edge server 199 which is used to initialise and store the first authoritative party 105 to the distributed database 110B.

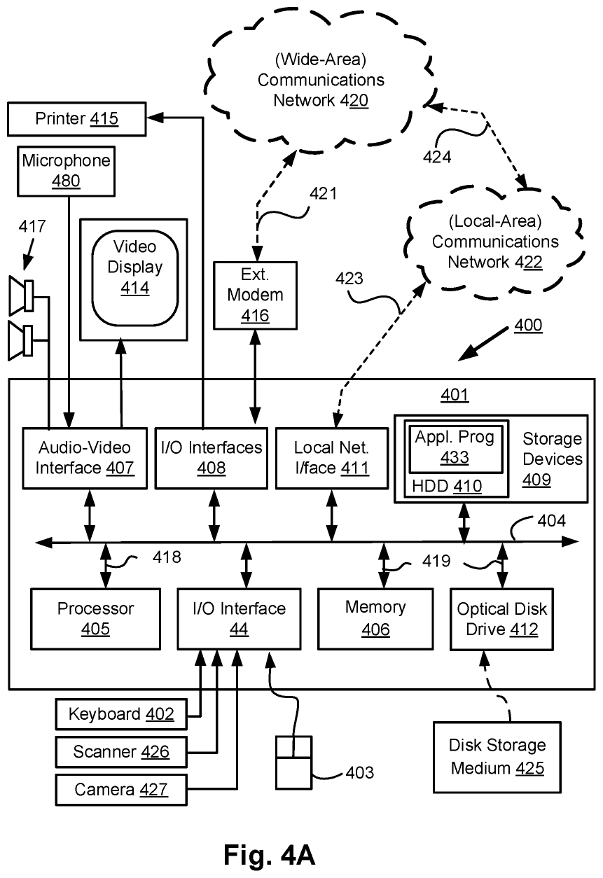

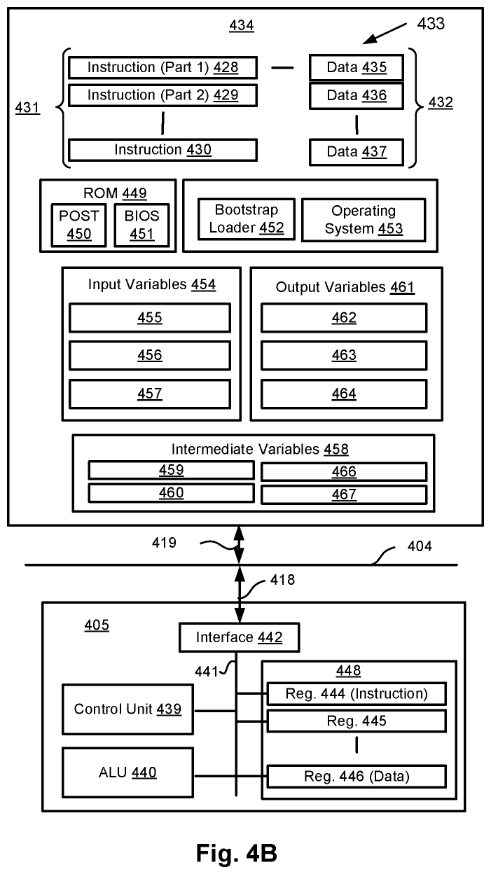

Referring to FIGS. 4A and 4B there is depicted a general-purpose computer system 400, upon which the various arrangements described can be practiced.

FIGS. 4A and 4B depict a general-purpose computer system 400, upon which the various arrangements described can be practiced.

As seen in FIG. 4A, the computer system 400 includes: a computer module 401; input devices such as a keyboard 402, a mouse pointer device 403, a scanner 426, a camera 427, and a microphone 480; and output devices including a printer 415, a display device 414 and loudspeakers 417. An external Modulator-Demodulator (Modem) transceiver device 416 may be used by the computer module 401 for communicating to and from a communications network 420 via a connection 421. The communications network 420 may be a wide-area network (WAN), such as the Internet, a cellular telecommunications network, or a private WAN. Where the connection 421 is a telephone line, the modem 416 may be a traditional “dial-up” modem. Alternatively, where the connection 421 is a high capacity (e.g., cable) connection, the modem 416 may be a broadband modem. A wireless modem may also be used for wireless connection to the communications network 420.

The computer module 401 typically includes at least one processor unit 405, and a memory unit 406. For example, the memory unit 406 may have semiconductor random access memory (RAM) and semiconductor read only memory (ROM). The computer module 401 also includes an number of input/output (I/O) interfaces including: an audio-video interface 407 that couples to the video display 414, loudspeakers 417 and microphone 480; an I/O interface 413 that couples to the keyboard 402, mouse 403, scanner 426, camera 427 and optionally a joystick or other human interface device (not illustrated); and an interface 408 for the external modem 416 and printer 415. In some implementations, the modem 416 may be incorporated within the computer module 401, for example within the interface 408. The computer module 401 also has a local network interface 411, which permits coupling of the computer system 400 via a connection 423 to a local-area communications network 422, known as a Local Area Network (LAN). As illustrated in FIG. 4A, the local communications network 422 may also couple to the wide network 420 via a connection 424, which would typically include a so-called “firewall” device or device of similar functionality. The local network interface 411 may comprise an Ethernet circuit card, a Bluetooth® wireless arrangement or an IEEE 802.11 wireless arrangement; however, numerous other types of interfaces may be practiced for the interface 411.

The I/O interfaces 408 and 413 may afford either or both of serial and parallel connectivity, the former typically being implemented according to the Universal Serial Bus (USB) standards and having corresponding USB connectors (not illustrated). Storage devices 409 are provided and typically include a hard disk drive (HDD) 410. Other storage devices such as a floppy disk drive and a magnetic tape drive (not illustrated) may also be used. An optical disk drive 412 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 400.

The components 405 to 413 of the computer module 401 typically communicate via an interconnected bus 404 and in a manner that results in a conventional mode of operation of the computer system 400 known to those in the relevant art. For example, the processor 405 is coupled to the system bus 404 using a connection 418. Likewise, the memory 406 and optical disk drive 412 are coupled to the system bus 404 by connections 419. Examples of computers on which the described arrangements can be practised include IBM-PC's and compatibles, Sun Sparcstations, Apple Mac™ or like computer systems.

The method described herein may be implemented using the computer system 400 wherein the processes may be implemented as one or more software application programs 433 executable within the computer system 400. In particular, the steps of the methods described in the present disclosure are effected by instructions 431 (see FIG. 4B) in the software 433 that are carried out within the computer system 400. The software instructions 431 may be formed as one or more code modules, each for performing one or more particular tasks. The software may also be divided into two separate parts, in which a first part and the corresponding code modules performs the disclosed methods and a second part and the corresponding code modules manage a user interface between the first part and the user.

The software may be stored in a computer readable medium, including the storage devices described below, for example. The software is loaded into the computer system 400 from the computer readable medium, and then executed by the computer system 400. A computer readable medium having such software or computer program recorded on the computer readable medium is a computer program product. The use of the computer program product in the computer system 400 preferably effects an advantageous apparatus for identity management in a computerised network such as an IoT network like a smart grid.

The software 433 is typically stored in the HDD 410 or the memory 406. The software is loaded into the computer system 400 from a computer readable medium, and executed by the computer system 400. Thus, for example, the software 433 may be stored on an optically readable disk storage medium (e.g., CD-ROM) 425 that is read by the optical disk drive 412. A computer readable medium having such software or computer program recorded on it is a computer program product. The use of the computer program product in the computer system 400 preferably effects an apparatus for identity management in a computerised network such as an IoT network like a smart grid.

In some instances, the application programs 433 may be supplied to the user encoded on one or more CD-ROMs 425 and read via the corresponding drive 412, or alternatively may be read by the user from the networks 420 or 422. Still further, the software can also be loaded into the computer system 400 from other computer readable media. Computer readable storage media refers to any non-transitory tangible storage medium that provides recorded instructions and/or data to the computer system 400 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computer module 401. Examples of transitory or non-tangible computer readable transmission media that may also participate in the provision of software, application programs, instructions and/or data to the computer module 401 include radio or infra-red transmission channels as well as a network connection to another computer or networked device, and the Internet or Intranets including e-mail transmissions and information recorded on Websites and the like.

The second part of the application programs 433 and the corresponding code modules mentioned above may be executed to implement one or more graphical user interfaces (GUIs) to be rendered or otherwise represented upon the display 414. Through manipulation of typically the keyboard 402 and the mouse 403, a user of the computer system 400 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 417 and user voice commands input via the microphone 480.

FIG. 4B is a detailed schematic block diagram of the processor 405 and a “memory” 434. The memory 434 represents a logical aggregation of all the memory modules (including the HDD 409 and semiconductor memory 406) that can be accessed by the computer module 401 in FIG. 4A.

When the computer module 401 is initially powered up, a power-on self-test (POST) program 450 executes. The POST program 450 is typically stored in a ROM 449 of the semiconductor memory 406 of FIG. 4A. A hardware device such as the ROM 449 storing software is sometimes referred to as firmware. The POST program 450 examines hardware within the computer module 401 to ensure proper functioning and typically checks the processor 405, the memory 434 (409, 406), and a basic input-output systems software (BIOS) module 451, also typically stored in the ROM 449, for correct operation. Once the POST program 450 has run successfully, the BIOS 451 activates the hard disk drive 410 of FIG. 4A. Activation of the hard disk drive 410 causes a bootstrap loader program 452 that is resident on the hard disk drive 410 to execute via the processor 405. This loads an operating system 453 into the RAM memory 406, upon which the operating system 453 commences operation. The operating system 453 is a system level application, executable by the processor 405, to fulfil various high level functions, including processor management, memory management, device management, storage management, software application interface, and generic user interface.

The operating system 453 manages the memory 434 (409, 406) to ensure that each process or application running on the computer module 401 has sufficient memory in which to execute without colliding with memory allocated to another process. Furthermore, the different types of memory available in the system 400 of FIG. 4A must be used properly so that each process can run effectively. Accordingly, the aggregated memory 434 is not intended to illustrate how particular segments of memory are allocated (unless otherwise stated), but rather to provide a general view of the memory accessible by the computer system 400 and how such is used.

As shown in FIG. 4B, the processor 405 includes a number of functional modules including a control unit 439, an arithmetic logic unit (ALU) 440, and a local or internal memory 448, sometimes called a cache memory. The cache memory 448 typically includes a number of storage registers 444-446 in a register section. One or more internal busses 441 functionally interconnect these functional modules. The processor 405 typically also has one or more interfaces 442 for communicating with external devices via the system bus 404, using a connection 418. The memory 434 is coupled to the bus 404 using a connection 419.

The application program 433 includes a sequence of instructions 431 that may include conditional branch and loop instructions. The program 433 may also include data 432 which is used in execution of the program 433. The instructions 431 and the data 432 are stored in memory locations 428, 429, 430 and 435, 436, 437, respectively. Depending upon the relative size of the instructions 431 and the memory locations 428-430, a particular instruction may be stored in a single memory location as depicted by the instruction shown in the memory location 430. Alternately, an instruction may be segmented into a number of parts each of which is stored in a separate memory location, as depicted by the instruction segments shown in the memory locations 428 and 429.

In general, the processor 405 is given a set of instructions which are executed therein. The processor 405 waits for a subsequent input, to which the processor 405 reacts to by executing another set of instructions. Each input may be provided from one or more of a number of sources, including data generated by one or more of the input devices 402, 403, data received from an external source across one of the networks 420, 402, data retrieved from one of the storage devices 406, 409 or data retrieved from a storage medium 425 inserted into the corresponding reader 412, all depicted in FIG. 4A. The execution of a set of the instructions may in some cases result in output of data. Execution may also involve storing data or variables to the memory 434.

The disclosed arrangements use input variables 454, which are stored in the memory 434 in corresponding memory locations 455, 456, 457. The arrangements produce output variables 461, which are stored in the memory 434 in corresponding memory locations 462, 463, 464. Intermediate variables 458 may be stored in memory locations 459, 460, 466 and 467.

Referring to the processor 405 of FIG. 4B, the registers 444, 445, 446, the arithmetic logic unit (ALU) 440, and the control unit 439 work together to perform sequences of micro-operations needed to perform “fetch, decode, and execute” cycles for every instruction in the instruction set making up the program 433. Each fetch, decode, and execute cycle comprises: a fetch operation, which fetches or reads an instruction 431 from a memory location 428, 429, 430; a decode operation in which the control unit 439 determines which instruction has been fetched; and an execute operation in which the control unit 439 and/or the ALU 440 execute the instruction.

Thereafter, a further fetch, decode, and execute cycle for the next instruction may be executed. Similarly, a store cycle may be performed by which the control unit 439 stores or writes a value to a memory location 432.

Each step or sub-process in the processes of the disclosed methods is associated with one or more segments of the program 433 and is performed by the register section 444, 445, 447, the ALU 440, and the control unit 439 in the processor 405 working together to perform the fetch, decode, and execute cycles for every instruction in the instruction set for the noted segments of the program 433.

The method of this disclosure may alternatively be implemented in dedicated hardware such as one or more integrated circuits performing the functions or sub functions as disclosed. Such dedicated hardware may include graphic processors, digital signal processors, or one or more microprocessors and associated memories.

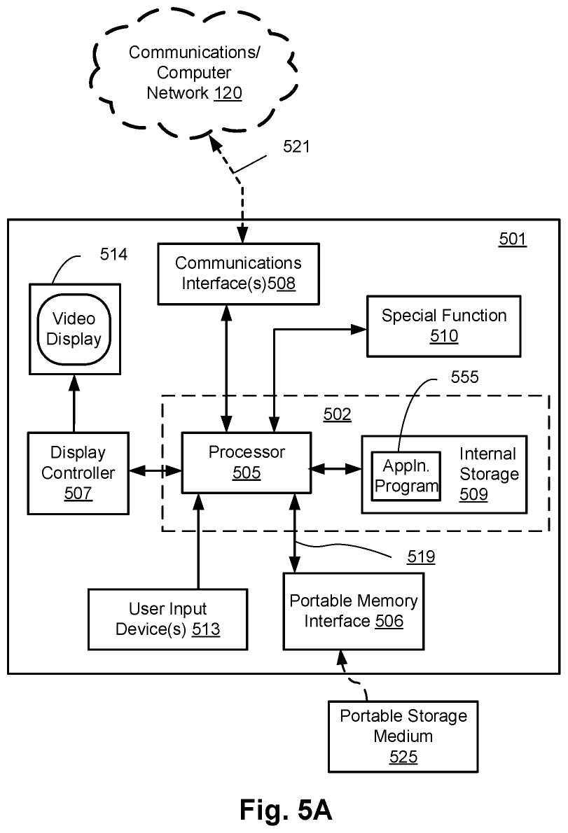

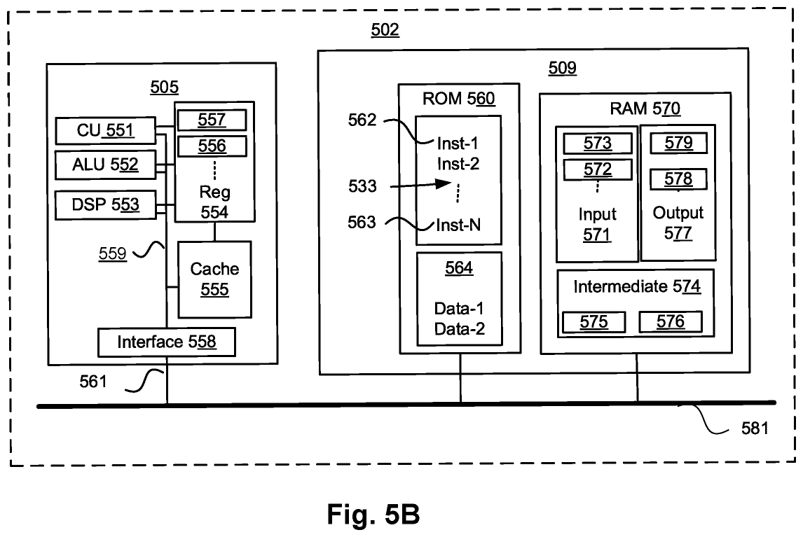

Referring to FIGS. 5A and 5B collectively form a schematic block diagram of a general purpose electronic device 501 including embedded components, which are suitable for use as computerised components of the computerised network, such as an IoT network like a smart grid. The electronic device 501 may be, for example, a sensing device, a PLC, an electronic actuator, or the like in which processing resources are limited.

As seen in FIG. 5A, the electronic device 501 comprises an embedded controller 502. Accordingly, the electronic device 501 may be referred to as an “embedded device.” In the present example, the controller 502 has a processing unit (or processor) 505 which is bi-directionally coupled to an internal storage module 509. The storage module 509 may be formed from non-volatile semiconductor read only memory (ROM) 560 and semiconductor random access memory (RAM) 570, as seen in FIG. 5B. The RAM 570 may be volatile, non-volatile or a combination of volatile and non-volatile memory.

The electronic device 501 can include a display controller 507, which is connected to a video display 514, such as a liquid crystal display (LCD) panel or the like. The display controller 507 is configured for displaying graphical images on the video display 514 in accordance with instructions received from the embedded controller 502, to which the display controller 507 is connected.

The electronic device 501 can also include user input devices 513 which are typically formed by keys, a keypad or like controls. In some implementations, the user input devices 513 may include a touch sensitive panel physically associated with the display 514 to collectively form a touch-screen. Such a touch-screen may thus operate as one form of graphical user interface (GUI) as opposed to a prompt or menu driven GUI typically used with keypad-display combinations. Other forms of user input devices may also be used, such as a microphone (not illustrated) for voice commands or a joystick/thumb wheel (not illustrated) for ease of navigation about menus.

As seen in FIG. 5A, the electronic device 501 can also comprise a portable memory interface 506, which is coupled to the processor 505 via a connection 519. The portable memory interface 506 allows a complementary portable memory device 525 to be coupled to the electronic device 501 to act as a source or destination of data or to supplement the internal storage module 509. Examples of such interfaces permit coupling with portable memory devices such as Universal Serial Bus (USB) memory devices, Secure Digital (SD) cards, Personal Computer Memory Card International Association (PCMIA) cards, optical disks and magnetic disks.

The electronic device 501 has a communications interface 508 to permit coupling of the device 501 to a computer or communications network 520 via a connection 521. The connection 521 may be wired or wireless. For example, the connection 521 may be radio frequency or optical. An example of a wired connection includes Ethernet. Further, an example of wireless connection includes Bluetooth™ type local interconnection, Wi-Fi (including protocols based on the standards of the IEEE 802.11 family), Infrared Data Association (IrDa) and the like.

Typically, the electronic device 501 is configured to perform some special function. The embedded controller 502, possibly in conjunction with further special function components 510, is provided to perform that special function. For example, where the device 501 is a digital camera, the components 510 may represent a lens, focus control and image sensor of the camera. The special function components 510 is connected to the embedded controller 502. As another example, the device 501 may be a mobile telephone handset. In this instance, the components 510 may represent those components required for communications in a cellular telephone environment. Where the device 501 is a portable device, the special function components 510 may represent a number of encoders and decoders of a type including Joint Photographic Experts Group (JPEG), (Moving Picture Experts Group) MPEG, MPEG-1 Audio Layer 3 (MP3), and the like.

The methods described hereinafter may be implemented using the embedded controller 502, where processes may be implemented as one or more software application programs 533 executable within the embedded controller 502. The electronic device 501 of FIG. 5A implements the described methods. In particular, with reference to FIG. 5B, the steps of the described methods are affected by instructions in the software 533 that are carried out within the controller 502. The software instructions may be formed as one or more code modules, each for performing one or more particular tasks. The software may also be divided into two separate parts, in which a first part and the corresponding code modules performs the described methods and a second part and the corresponding code modules manage a user interface between the first part and the user.

The software 533 of the embedded controller 502 is typically stored in the non-volatile ROM 560 of the internal storage module 509. The software 533 stored in the ROM 560 can be updated when required from a computer readable medium. The software 533 can be loaded into and executed by the processor 505. In some instances, the processor 505 may execute software instructions that are located in RAM 570. Software instructions may be loaded into the RAM 570 by the processor 505 initiating a copy of one or more code modules from ROM 560 into RAM 570. Alternatively, the software instructions of one or more code modules may be pre-installed in a non-volatile region of RAM 570 by a manufacturer. After one or more code modules have been located in RAM 570, the processor 505 may execute software instructions of the one or more code modules.

The application program 533 is typically pre-installed and stored in the ROM 560 by a manufacturer, prior to distribution of the electronic device 501. However, in some instances, the application programs 533 may be supplied to the user encoded on one or more CD-ROM (not shown) and read via the portable memory interface 506 of FIG. 5A prior to storage in the internal storage module 509 or in the portable memory 525. In another alternative, the software application program 533 may be read by the processor 505 from the network 520, or loaded into the controller 502 or the portable storage medium 525 from other computer readable media. Computer readable storage media refers to any non-transitory tangible storage medium that participates in providing instructions and/or data to the controller 502 for execution and/or processing. Examples of such storage media include floppy disks, magnetic tape, CD-ROM, a hard disk drive, a ROM or integrated circuit, USB memory, a magneto-optical disk, flash memory, or a computer readable card such as a PCMCIA card and the like, whether or not such devices are internal or external of the device 501. Examples of transitory or non-tangible computer readable transmission media that may also participate in the provision of software, application programs, instructions and/or data to the device 501 include radio or infra-red transmission channels as well as a network connection to another computer or networked device, and the Internet or Intranets including e-mail transmissions and information recorded on Websites and the like. A computer readable medium having such software or computer program recorded on it is a computer program product.

The second part of the application programs 533 and the corresponding code modules mentioned above may be executed to implement one or more graphical user interfaces (GUIs) to be rendered or otherwise represented upon the display 514 of FIG. 5A. Through manipulation of the user input device 513 (e.g., the keypad), a user of the device 501 and the application programs 533 may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers (not illustrated) and user voice commands input via the microphone (not illustrated).

FIG. 5B illustrates in detail the embedded controller 502 having the processor 505 for executing the application programs 533 and the internal storage 509. The internal storage 509 comprises read only memory (ROM) 560 and random-access memory (RAM) 570. The processor 505 is able to execute the application programs 533 stored in one or both of the connected memories 560 and 570. When the electronic device 501 is initially powered up, a system program resident in the ROM 560 is executed. The application program 533 permanently stored in the ROM 560 is sometimes referred to as “firmware”. Execution of the firmware by the processor 505 may fulfil various functions, including processor management, memory management, device management, storage management and user interface.

The processor 505 typically includes a number of functional modules including a control unit (CU) 551, an arithmetic logic unit (ALU) 552, a digital signal processor (DSP) 553 and a local or internal memory comprising a set of registers 554 which typically contain atomic data elements 556, 557, along with internal buffer or cache memory 555. One or more internal buses 559 interconnect these functional modules. The processor 505 typically also has one or more interfaces 558 for communicating with external devices via system bus 581, using a connection 561.

The application program 533 includes a sequence of instructions 562 though 563 that may include conditional branch and loop instructions. The program 533 may also include data, which is used in execution of the program 533. This data may be stored as part of the instruction or in a separate location 564 within the ROM 560 or RAM 570.

In general, the processor 505 is given a set of instructions, which are executed therein. This set of instructions may be organised into blocks, which perform specific tasks or handle specific events that occur in the electronic device 501. Typically, the application program 533 waits for events and subsequently executes the block of code associated with that event. Events may be triggered in response to input from a user, via the user input devices 513 of FIG. 5A, as detected by the processor 505. Events may also be triggered in response to other sensors and interfaces in the electronic device 501.

The execution of a set of the instructions may require numeric variables to be read and modified. Such numeric variables are stored in the RAM 570. The disclosed method uses input variables 571 that are stored in known locations 572, 573 in the memory 570. The input variables 571 are processed to produce output variables 577 that are stored in known locations 578, 579 in the memory 570. Intermediate variables 574 may be stored in additional memory locations in locations 575, 576 of the memory 570. Alternatively, some intermediate variables may only exist in the registers 554 of the processor 505.

The execution of a sequence of instructions is achieved in the processor 505 by repeated application of a fetch-execute cycle. The control unit 551 of the processor 505 maintains a register called the program counter, which contains the address in ROM 560 or RAM 570 of the next instruction to be executed. At the start of the fetch execute cycle, the contents of the memory address indexed by the program counter is loaded into the control unit 551. The instruction thus loaded controls the subsequent operation of the processor 505, causing for example, data to be loaded from ROM memory 560 into processor registers 554, the contents of a register to be arithmetically combined with the contents of another register, the contents of a register to be written to the location stored in another register and so on. At the end of the fetch execute cycle the program counter is updated to point to the next instruction in the system program code. Depending on the instruction just executed this may involve incrementing the address contained in the program counter or loading the program counter with a new address in order to achieve a branch operation.

Each step or sub-process in the processes of the methods described below is associated with one or more segments of the application program 533, and is performed by repeated execution of a fetch-execute cycle in the processor 505 or similar programmatic operation of other independent processor blocks in the electronic device 501.

A number of cryptographic algorithms are used to support the disclosed method and system. This includes Elliptic Curve Digital Signature Algorithm (ECDSA) and a Secure Pseudo-Random Function (PRF).

An ECDSA scheme D consists of three polynomial-time algorithms (Gen; Sig; V Sig). The probabilistic key generation n and returns a pair of keys (kₚ; kuₚ), where kₚ is the secret signing key and kuₚ is the public verification key. The possibly probabilistic signing algorithm Sig expects a private key kₚ and a message m∈{0,1}*, and returns a signature Sig(kₚ, m). The deterministic verification algorithm V Sig expects a public key kuₚ, a message m∈{0, 1}*, and a message authentication code β and returns VSigₖᵤ_{ₚ} (m, β)∈{true, false}. For every η, key pair (kₚ; kuₚ) that is generated by Gen(1^{η}), and message m∈{0, 1}*, it holds that VSigₖᵤ_{ₚ}(m, Sig(m))=true.

A family of functions F=(F_{η})_{η∈N} with F_{η}:{0, 1}^{η}×{0, 1}*→{0,1}^{η} is called a Secure PRF family if it is efficiently computable and for every polynomial time algorithm E^{O(.)} with access to oracle O, the PRF advantage of E as defined by Equation 1 is negligible as a function in η and a bit string ω:

Adv_{E,F}^{PRF}(1^{η},ω):=|Pr[Exp_{E,F}^{PRF-1}(1^{η,ω)}=1]−Pr[Exp_{E,F}^{PRF-0}(1^{η,ω})=1]| Equation 1

As mentioned above, a plurality of transactions 160, 170, 180 are utilised to support the identification and authentication of computerised components and services, such as IoT components and services, like smart grid components and services. These transactions include an identity issuing transaction (IDT) 160, an attribute identifier issuing transaction (ATT) 170, and an identity/attribute identifier check transaction (ICT) 180. Each of these transactions will be described below in further detail.

An IDT 160 is generated by a component (or service) to request an identity from an authoritative (i.e. genuine) party such as a smart grid party. Upon the successful execution of IDT 160, the party returns a digitally signed identity to the component. Once the component or service has obtained an identity, such component or service becomes a genuine component in the computerised network.

An ATT 170 is generated by a genuine component (or service) to request an attribute identifier of its feature from an authoritative party such as a genuine smart grid party. Upon the successful execution of ATT 170, the party returns a digitally signed attribute identifier of the feature to the component or service.

An ICT 180 is generated by an authoritative party such as a genuine smart grid party to verify the identity or attribute identifier of a component (or service). Upon the successful execution of ICT 180, the party marks the component as “Valid”.

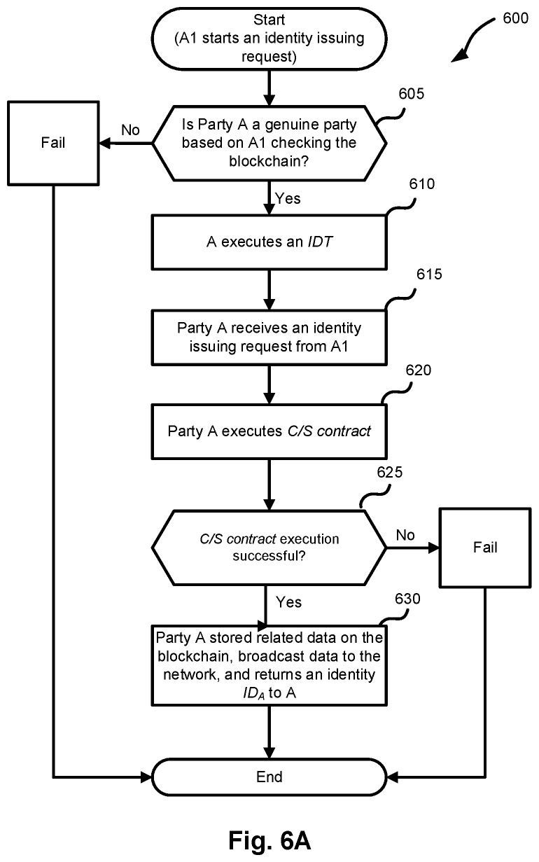

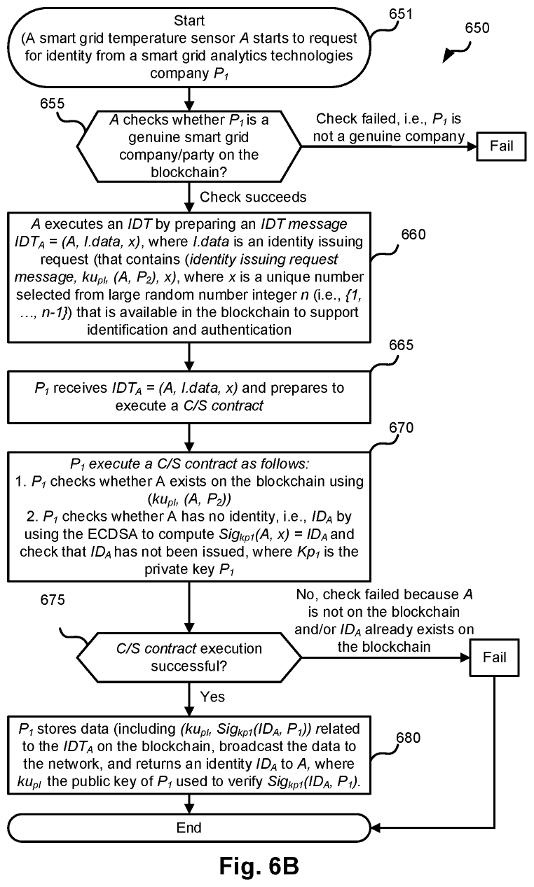

As discussed above, various smart contracts 185, 190, 195 are invoked and associated logic within executed based on the initiation of a transaction. These smart contracts 185, 190, 195, as shown in FIGS. 6A to 8B, are used to facilitate, verify, and enforce agreements with the support of the transactions. As discussed above a first, second and third smart contracts 185, 190, 195 can be invoked. More specifically, the three smart contracts include: a components and services contract (C/S contract) 185 which is based on the ECDSA and used for adding a new component or service as well as approving an attribute identifier issued by a genuine party; ii) a parties contract (P contract) 190 which is based on the ECDSA and PRF and used for issuing an attribute identifier to a genuine component or service as well as deploying a new party to the computerised network; and iii) an identity and attribute identifier check contract (ID-AT check contract) 195 is based on the ECDSA and used for verifying the identity or attribute identifiers of a component or service. The smart contracts 185, 190, 195 and the data required to execute the contracts can be obtained from the data already stored on the blockchain to provide a high degree of assurance and simplification of contract execution.

The identity management method comprises of three main phases including an identity issuing phase, an attribute identifier phase and an identity/attribute identifier check phase. Each of these phases will be discussed below in further detail.

Referring to FIG. 6A, during the identity issuing phase, a component A (or service) uses IDT to obtain a unique identity from a genuine party P₁ via the C/S contract. Before requesting an identity, A checks the blockchain whether P₁ is a genuine party (step 605) and proceed if the check succeeds (step 610). When P₁ receives IDT_{A}=(A; I.data; x), where A is the name of the component, I.data is an identity issuing request and x∈{1, . . . , n−1} is a random number and n is a large randomly selected integer (step 615), it executes the C/S contract (step 620) as follows: i) it checks the blockchain whether A is a genuine name and has not been assigned an identity, and uses

$${Sig}_{{k}_{{p}_{1}}} ( . ) as {Sig}_{{k}_{{p}_{1}}} ( A , x ) = {ID}_{A}$$

if the check succeeds, where kₚ₁ is the private key of P₁; and ii) it verifies that ID_{A} has not been issued. If the verification succeeds, ID_{A} becomes the digitally signed identity of A. Upon the successful execution of IDT, P₁ stores all the data related to this transaction on the blockchain, broadcasts the data to the network, and returns ID_{A} to A (step 630). Only genuine parties issue identities to ensure high identity assurance. As can be appreciated, the verifications of the component and the party provide mutual authentication. In some instances, an identity (say, ID_{A}) can be revoked due to violation of IDT, wherein the party (say, P₁) marks ID_{A} as revoked, broadcasts the data to the network, and stores ID_{A}(revoked) on the blockchain.

Referring to FIG. 6B there is shown a more specific flow diagram representing the identity issuing phase where a smart grid analytics technologies company P₁ issues an identity to a smart grid temperature sensor A. In particular, the smart grid temperature sensor A checks whether the smart grid company P₁ is on the blockchain. Steps 660 to 680 are performed similarly to that described in relation to step 610 to 630 respectively.

More specifically at step 660, the method includes smart grid temperature sensor A executing an IDT by preparing an IDT message IDT_{A}=(A, I.data, x), where I.data is an identity issuing request (that contains (identity issuing request message, kuₚₗ, (A, P₂), x), where x is a unique number selected from large random number integer n (i.e., {1, . . . , n−1}) that is available in the blockchain to support identification and authentication.

At step 665, smart grid company P₁ receives IDT_{A}=(A, I.data, x) and prepares to execute a C/S contract.

At step 670, the smart grid company P₁ executes a C/S contract as follows: 1. P₁ checks whether A exists on the blockchain using (kuₚₗ, (A, P₂)); and 2. P₁ checks whether A has no identity, i.e., ID_{A} by using the ECDSA to compute Sigₖₚ₁(A, x)=ID_{A} and check that ID_{A} has not been issued, where Kp₁ is the private key P₁.

At step 675, the smart grid company P₁ determines if the C/S contract execution was successful. If the check failed because A is not on the blockchain and/or ID_{A} already exists on the blockchain, then the method ends. Otherwise, if the check succeeded, the method proceeds to step 680.

At step 680, the method includes the smart grid company P₁ storing data (including (kuₚₗ, Sigₖₚ₁(ID_{A}, P₁)) related to the IDT_{A} on the blockchain, broadcast the data to the network, and returns an identity ID_{A} to A, where kuₚₗ the public key of P₁ used to verify Sigₖₚ₁(ID_{A}, P₁).

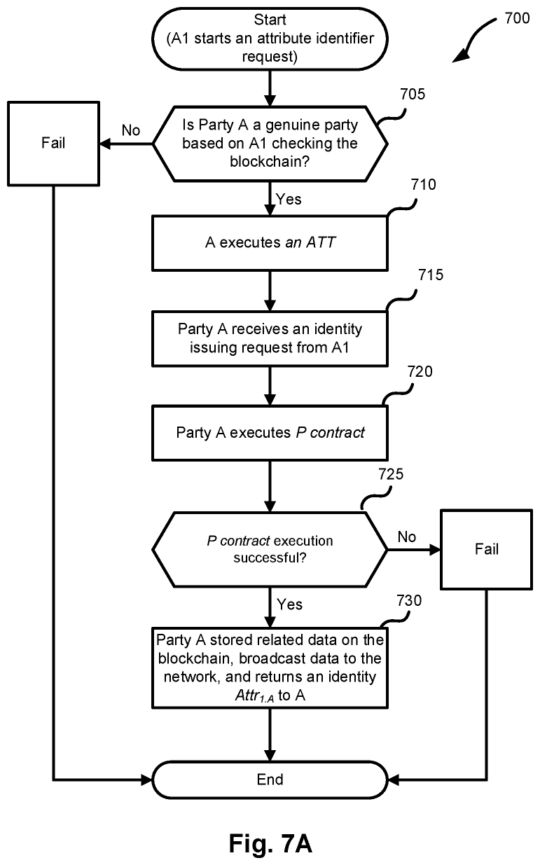

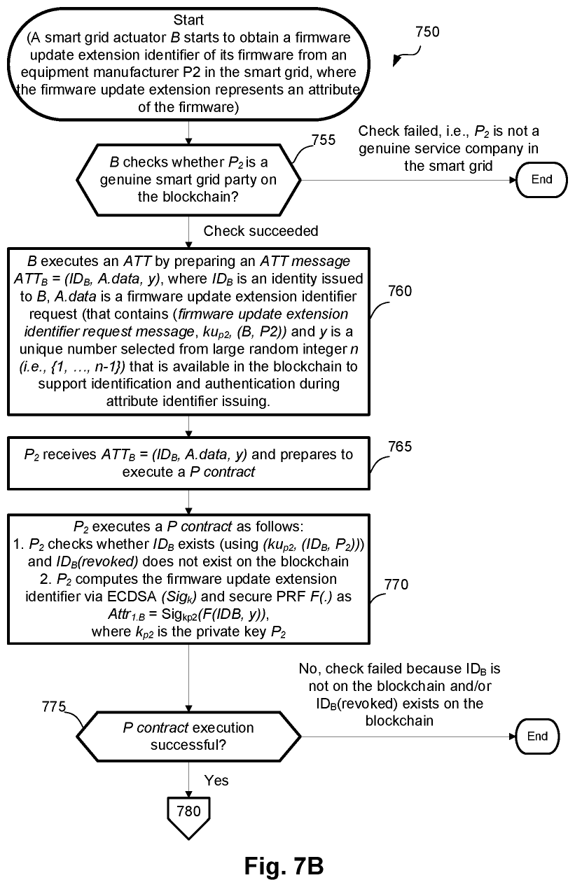

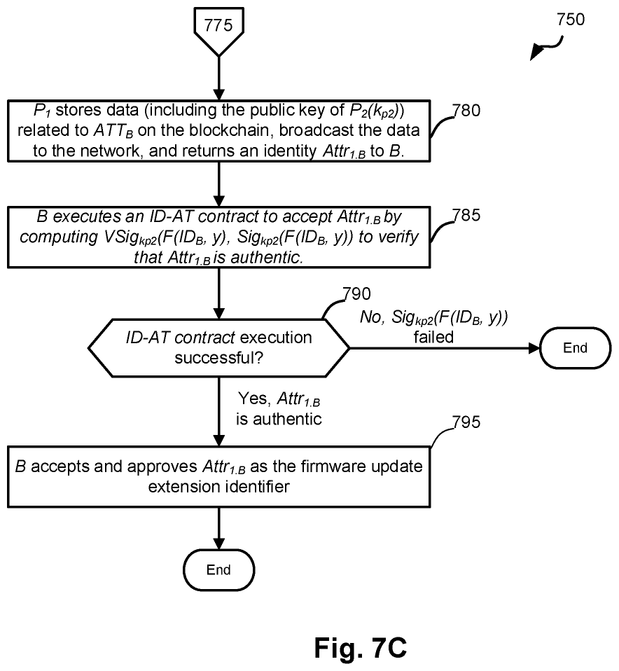

Referring to FIG. 7A, during attribute identifier issuing phrase, a genuine component A (or a genuine service) uses ATT to obtain an attribute identifier of its feature from a genuine party P₁ via the P contract. Before requesting an attribute identifier, A checks the blockchain whether P₁ is a genuine party (step 705) and proceed if the check succeeds (step 710). When P₁ receives (step 715) ATT=(ID_{A}; A.data; y), where ID_{A} is the identity of A, A.data is an attribute identifier request, and Y∈{1, . . . , n−1} is a random number, it executes (step 720) the P contract as follows: i) it checks (step 725) the blockchain whether ID_{A} exists and ID_{A}(revoked) does not exist on the blockchain. If the checks succeed, P₁ computes an attribute identifier Attr_{1.A}=Sigₖₚ₁ (F(ID_{A}; y)), where F is a Secure PRF. Then, P₁ stores (step 730) all the data related to this transaction in the blockchain, broadcasts the data to the network, and returns Attr_{1.A} to A.

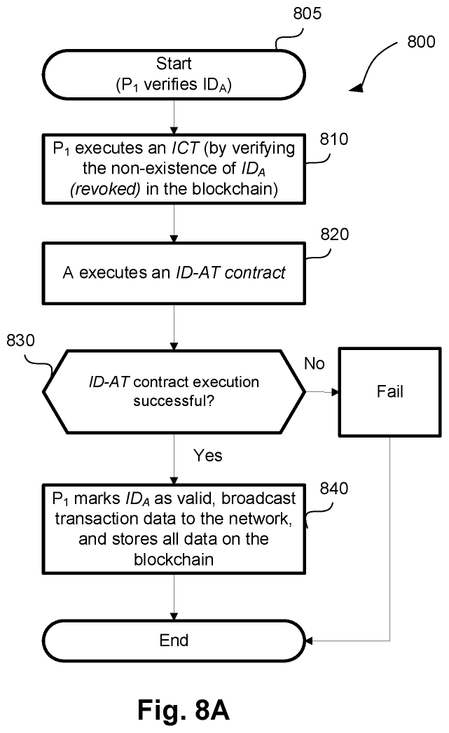

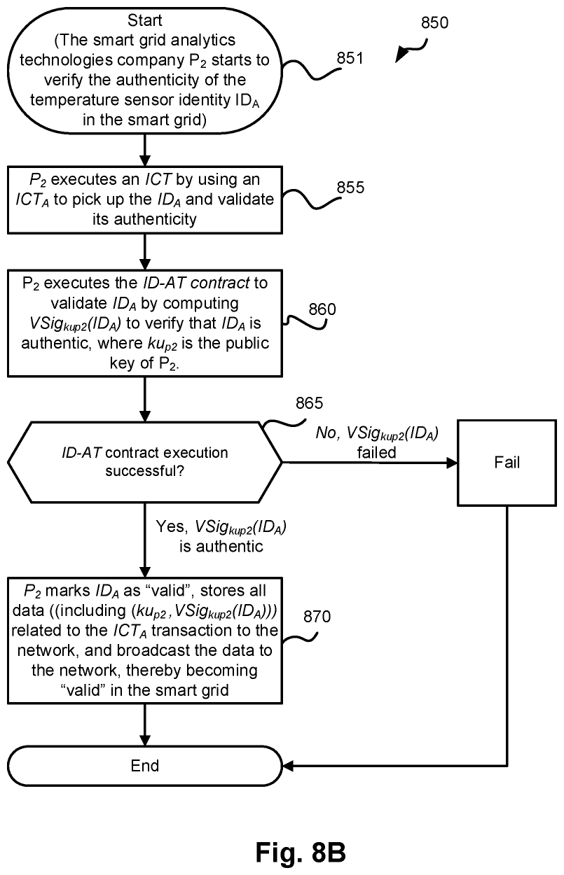

Referring to FIGS. 7B and 7C there is shown a more specific example representing the attribute identifier issuing phrase where an identity for a firmware (i.e. attribute) of a smart grid actuator is issued. FIGS. 7B and 7C refer to an equipment manufacturer P₂ in the smart grid. Steps 755 to 780 are performed similarly to the steps described in relation to FIG. 7A—although it will be appreciated that references A and B have been interchanged for this specific example. However, steps 785 to 795 involve additional steps where the smart grid actuator B executes the ID-AT check contract to accept Attr_{1.B}, i.e., B uses the public key kuₚ₁ of P₂ via VSigₖᵤₚ₁ (F(ID_{B}; y); Sigₖₚ₁ (F(ID_{B}; y))) to verify that Attr_{1.B} is authentic and then approves Attr_{1.B} as the attribute identifier of the firmware if the verification succeeds, where VSigₖᵤₚ₁ (.) is the verification part of Sigₖₚ₁(.). Steps 785 to 795 represent the execution of the identity/attribute identifier check phase as discussed below in relation to FIG. 8A.

More specifically, at the start of the method 750, a smart grid actuator B starts to obtain a firmware update extension identifier of its firmware from an equipment manufacturer P₂ in the smart grid, where the firmware update extension represents an attribute of the firmware.

At step 755, the method 750 includes the smart grid actuator B checking whether P₂ is a genuine smart grid party on the blockchain. In response to a successful check, the method proceeds to step 760. Otherwise, in response to an unsuccessful check where it is determined that P₂ is not a genuine service company in the smart grid, the method ends.

At step 760, the method 750 includes the smart grid actuator B executing an ATT by preparing an ATT message ATT_{B}=(ID_{B}, A.data, y), where ID_{B} is an identity issued to B, A.data is a firmware update extension identifier request (that contains (firmware update extension identifier request message, kuₚ₂, (B, P2)) and y is a unique number selected from large random integer n (i.e., {1, . . . , n−1}) that is available in the blockchain to support identification and authentication during attribute identifier issuing.

At step 765, the method 750 includes P₂ receiving ATT_{B}=(ID_{B}, A.data, y) and preparing to execute a P contract.

At step 770, the method 750 includes P₂ executing the P contract as follows: 1. P₂ checks whether ID_{B} exists (using (kuₚ₂, (ID_{B}, P₂))) and ID_{B}(revoked) does not exist on the blockchain; and 2. P₂ computes the firmware update extension identifier via ECDSA (Sigₖ) and secure PRF F(.) as Attr_{1.B}=Sigₖₚ₂(F(ID_{B}, y)), where kₚ₂ is the private key P₂.

At step 775, the method 750 includes P₂ determining if the P contract execution was successful. If successful, the method proceeds to step 780, otherwise, because the check fails due to ID_{B} not being on the blockchain and/or ID_{B}(revoked) existing on the blockchain, the method 750 ends.

At step 780, the method 750 includes P₁ storing data (including the public key of P₂(kₚ₂)) related to ATT_{B} on the blockchain, broadcasting the data to the network, and returning an identity Attr_{1.B} to B.

At step 785, the method 750 includes B executing an ID-AT contract to accept Attr_{1.B} by computing VSigₖₚ₂(F(ID_{B}, y), Sigₖₚ₂(F(ID_{B}, y)) to verify that Attr_{1.B} is authentic.

At step 790, the method 750 includes B determining if the ID-AT contract execution was successful. In particular, if the ID-AT contract execution was unsuccessful because Sigₖₚ₂(F(ID_{B}, y)) failed, the method ends. However, if the if the ID-AT contract execution was successful because Attr_{1.B} was authentic, the method 750 proceeds to step 795.

At step 795, the method 750 includes B accepting and approving Attr_{1.B} as the firmware update extension identifier.

Referring to FIG. 8A, during the identity/attribute identifier check phase where a genuine party P₁ uses ICT to verify authenticity of an issued identity (say, ID_{A}) or attribute identifier of a component A (or service) via the ID-AT check contract. In this case, P₁ executes the ID-AT contract as VSigₖᵤₚ₁ (ID_{A}). If the verification succeeds, P₁ marks ID_{A} as “Valid”, broadcasts the transaction data to the network, and stores all the data on the blockchain.

Referring to FIG. 8B there is shown a more specific flowchart representing the identity/attribute identifier check phase where a smart grid analytics technologies company P₂ uses ICT to verify authenticity of a temperature sensor identity ID_{A} via the ID-AT check contract. Steps 851 to 870 effectively correspond to steps 810 to 840.

More specifically, at the start of the method 850, the smart grid analytics technologies company P₂ starts to verify the authenticity of the temperature sensor identity ID_{A} in the smart grid.

At step 855, the method 850 includes P₂ executing an ICT by using an ICT_{A} to pick up the ID_{A} and validating its authenticity.

At step 860, the method 850 includes P₂ executing the ID-AT contract to validate ID_{A} by computing VSigₖᵤₚ₂(ID_{A}) to verify that ID_{A} is authentic, where kuₚ₂ is the public key of P₂.

At step 865, the method 850 includes P₂ determining if the ID-AT contract execution was successful. If successful (VSigₖᵤₚ₂(ID_{A}) is authentic), the method proceeds to step 870. Otherwise, if P₂ determines that the ID-AT contract execution was unsuccessful (VSigₖᵤₚ₂(ID_{A}) failed), the method 850 ends.

At step 870, the method 850 includes P₂ marking ID_{A} as “valid”, storing all data ((including (kuₚ₂, VSigₖᵤₚ₂(ID_{A}))) related to the ICT_{A} transaction to the network, and broadcasting the data to the network, thereby becoming “valid” in the smart grid. The method 850 then ends.

The transactions discussed above provide a number of advantages. In particular, an adversary can neither issue nor verify one or more identities or attribute identifiers of a component or service. Furthermore, there is no central authority or trusted third party during the execution of the transactions. Moreover, security agreement is reached without the third party.

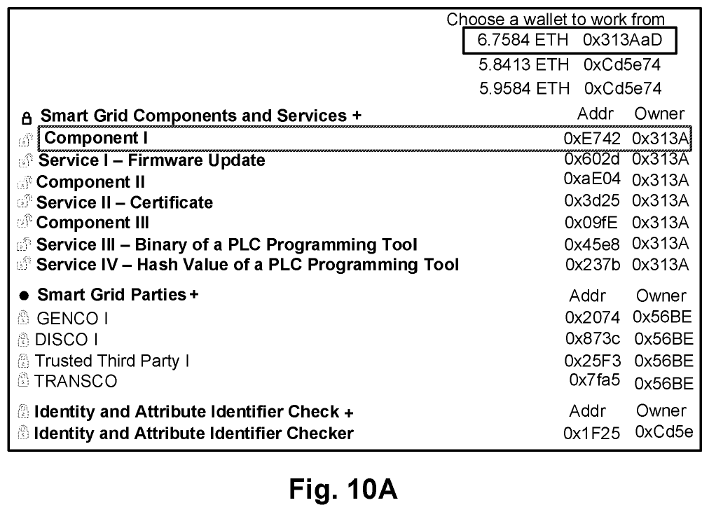

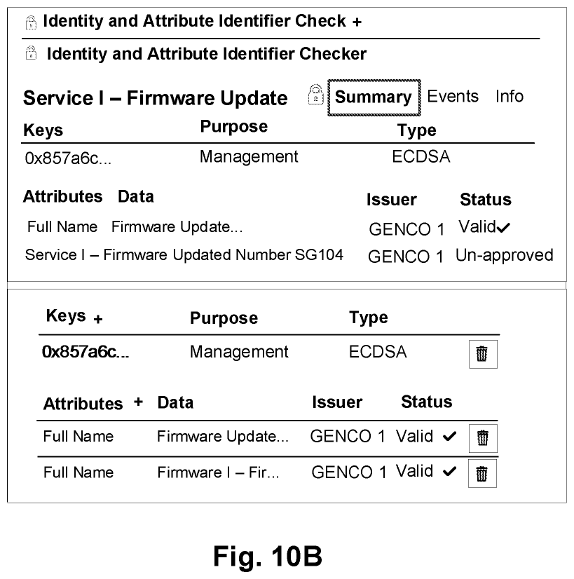

In certain implementations of the disclosed method, the proposed ERC 725 blockchain-based identity standard was modified to construct the identity management method/system and components. This implementation required the introduction of Secure PRF and using the Secure PRF with the ECDSA to implement the cryptographic algorithms used in techniques disclosed in the present disclosure. Furthermore, the ERC 725's Rivest-Shamir-Adleman (RSA) keys was replaced with Elliptic Curve Diffie-Hellman (ECDH) keys to enhance the security and performance of disclosed method and system. Similar to the ERC 725 standard, the disclosed implementation uses a key manager for managing cryptographic keys. An interface presented via a party computerised device for implementing identity management as disclosed is shown in FIG. 10A.

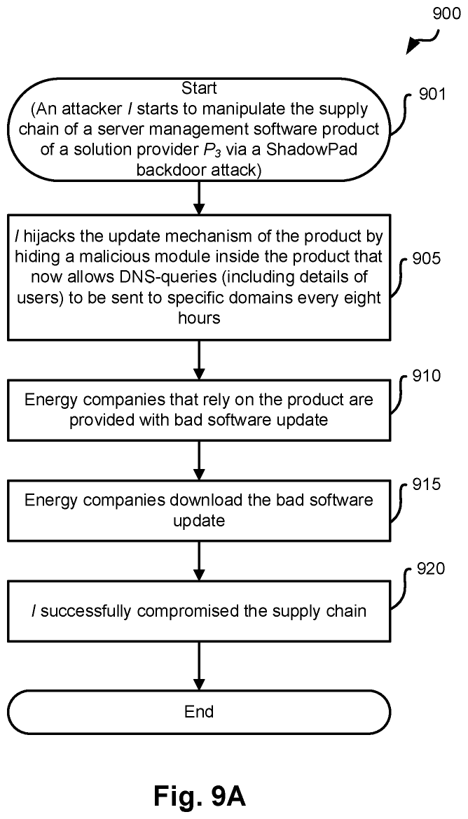

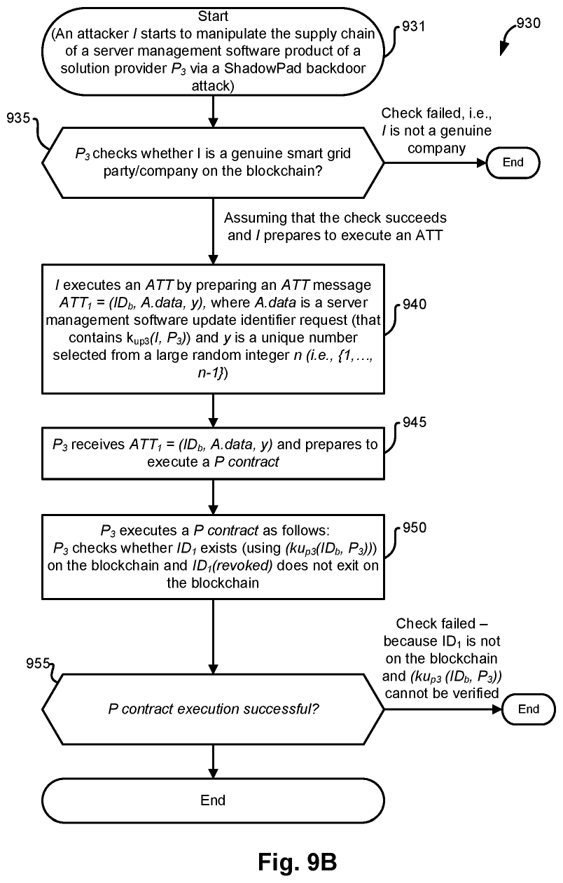

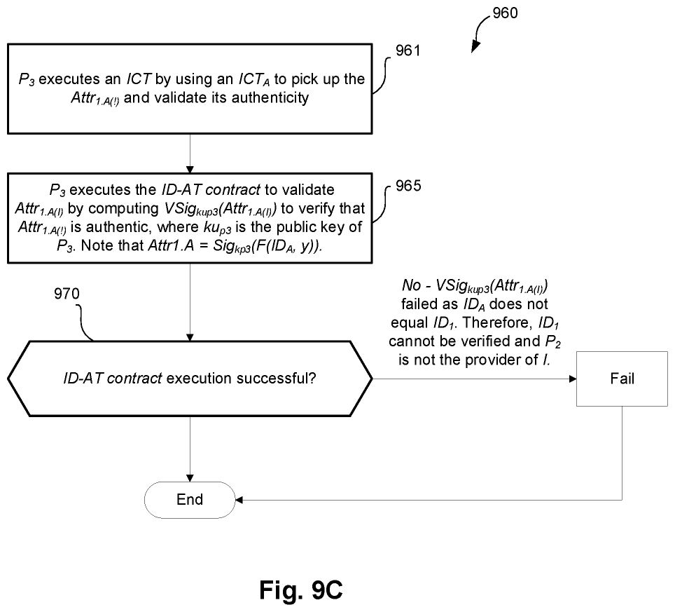

The disclosed method and system was analysed based on supply chain attacks to mitigate real-world supply chain attacks for networks such as IoT networks like a smart grid. The 2017 ShadowPad backdoor was analysed with reference to the disclosed method and system. FIGS. 9A and 9B are described with reference to FIGS. 10A and 10B which show an interface related to the mitigation of real-world supply chain attacks for networks such as IoT networks like a smart grid. In particular, As shown in FIG. 9A, the ShadowPad backdoor manipulated the supply chain of a server management product used by energy companies and allowed attackers I to hijack the update mechanism of the product. In particular, at step 905 the attacker I hijacks the update mechanism of the product by hiding a malicious module inside the product that allows DNS queries (including details of users) to be sent to specific domain periodically (e.g. every 8 hours). At step 910, energy companies that rely on the product are provided with a malicious software update. At step 915, the energy companies download the malicious software update. At step 920, the attacker I has successfully compromised the supply chain of the network. The disclosed method and system mitigates such an attack, as shown in FIGS. 9B and 9C by ensuring that an attribute identifier is issued to every update of a service (via IDT and C/S contract—step 955 as shown in FIG. 9B) and the service checks and approves the attribute identifier (via ICT and ID-AT contract—step 970 in FIG. 9C) before it is marked as “Valid” for use by the companies P₃. If an update with attribute identifier is assigned to a service, the status of the update is unapproved until it has been approved by the service and then the update status becomes valid as shown in the interface of FIG. 10B. Thus, the unapproved update cannot be used by the companies P₃ (or smart grid parties).

The disclosed method and system was analysed based on a further supply chain attack involving Trojan implants and watering hole attacks that target resources in a known location visited by smart grid parties. Attackers compromised trusted websites of PLC vendors and changed the actual binary on the websites and the hash value associated with downloading the PLC programming tool. Unfortunately, smart grid parties can still verify that they downloaded the right tool. Thus, having a trusted website with hash values does not mitigate supply chain attacks on trusted resources. However, utilising the disclosed method and system for identity management in a computer network, the new binary and hash value associated with every PLC cannot be valid since the adversary cannot store data on the blockchain. Additionally, since the binary or hash value does not have an attribute identifier, the smart grid parties can verify that the data has not been validated. Thus, the disclosed method and system for identity management mitigates Trojanized software and watering hole attacks. Note that the success probability of a computationally bounded adversary to execute any transaction in disclosed method and system is negligible since the attacker's name or identity cannot be verified. Thus, the disclosed method and system provides real-time mitigation of supply chain attacks related to the above unverified product updates and Trojanized software.

### INDUSTRIAL APPLICABILITY

The arrangements described are applicable to the computer and data processing industries and particularly for the supply chain industries for computerised networks such as IoT networks.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

1. A computer implemented method of performing blockchain-based identity management for a supply chain of a computerised network, wherein the method comprises:
receiving, by a computerised device of a party, an identity issuing transaction initiated by a computerised component or service being in the supply chain, the identity issuing transaction being indicative of a name of the computerised component or service, an identity issuing request message, and a first random number obtained from a distributed database, wherein the identity issuing transaction is initiated by the computerised component or service in response to determining the party is an authoritative party recorded in the blockchain and permitted to issue an identity;
invoking a first smart contract;
executing an identity issuance logic of the first smart contract to:
determine whether the computerised component or service has been recorded in the blockchain, and the computerised component or service has not been issued an identity; and
generate, in response to a positive determination, an identity for the computerised component or service based on the name of the computerised component or service, the identity issuing request message, the first random number and a digital signature algorithm;
storing first transaction data associated with executing the identity issuance logic of the first smart contract on the blockchain which is broadcast to the computerised network; and
transferring, to the computerised component or service, the generated identity for use in authenticating the computerised component or service in the supply chain of the computerised network.

2. The computer implemented method of claim 1, wherein the digital signature algorithm uses a private key of the authoritative party to generate the identity of the computerised component or service, and
wherein the identity is a digitally signed identifier using the private key.

3. The computer implemented method of claim 1, wherein the method further comprises:
receiving, by the computerised device of the party, an attribute identifier issuing transaction initiated by the computerised component or service after being issued with the identity, the attribute identifier issuing transaction being indicative of the identity of the computerised component or service, an attribute identifier request message, and a second random number obtained from the distributed database, wherein the attribute identifier issuing transaction is initiated by the computerised component or service in response to determining the party is the authoritative party recorded in the blockchain and permitted to issue an attribute identifier;
invoking a second smart contract;
executing an attribute identifier issuance logic of the second smart contract to:
determine whether the identity of the computerised component or service is recorded in the blockchain and whether no revocation of the identity of the computerised component or service is recorded in the blockchain;
generate, in response to a positive determination, the attribute identifier for an attribute of the computerised component or service based on the attribute identifier request message, the second random number and a digital signature algorithm;
storing second transaction data associated with executing the attribute identifier issuance logic of the second smart contract on the blockchain which is broadcast to the computerised network; and
transferring, to the computerised component or service, the generated attribute identifier for use in authenticating the attribute of the computerised component or service in the supply chain of the computerised network.

4. The computer implemented method of claim 3, wherein generating the attribute identifier for the attribute of the computerised component or service is further based on a pseudo-random function which is dependent upon the second random number and the identity of the computerised component or service.

5. The computer implemented method of claim 3, wherein the digital signature algorithm uses a private key of the authoritative party to generate the attribute identifier of the attribute of the computerised component or service, and
wherein the attribute identifier is a digitally signed attribute identifier using the private key.

6. The computer implemented method according to claim 1, wherein the method further comprises:
invoking a third smart contract to authenticate identification data including one of the identity of the computerised component or service or an attribute identifier of the computerised component or service;
executing an identification data check logic of the third smart contract to verify if the identification data is authentic; and
storing, in response to the identification data being verified as authentic, third transaction data associated with executing the identification data check logic of the third smart contract on the blockchain which is broadcast to the computerised network.

7. The computer implemented method of claim 6, wherein the digital signature algorithm uses a public key corresponding to a private key of the authoritative party to verify if the identification data is authentic.

8. The computer implemented method of claim 1, wherein the digital signature algorithm is Elliptic Curve Digital Signature Algorithm (ECDSA).

9. The computer implemented method of claim 1, wherein the method further comprises:
storing revocation transaction data on the blockchain which is broadcast to the computerised network in response to determining that the computerised component or service has violated the first smart contract,
wherein the revocation transaction data is indicative of the revocation of the identity of the computerised component or service.

10. The computer implemented method of claim 1, wherein the method comprises using Transport Layer Security (TLS) to establish a secure communication channel for data exchange.

11. The computer implemented method of claim 1, wherein the method comprises using a key agreement protocol based on or including Elliptic-curve Diffie-Hellman (ECDH) to establish a secure communication channel for data exchange.

12. The computer implemented method of claim 1, wherein the computerised network is an Internet of Things (IoT) network.

13. The computer implemented method of claim 12, wherein the IoT network is a smart grid network.

14. A computer implemented system including one or more memories having stored therein computer executable instructions, and one or more processors configured to execute the computer executable instructions to cause the computer implemented system to implement the computer implemented method of claim 1.

15. One or more non-transitory computer readable storage mediums having stored therein computer executable instructions for configuring a computer implemented system having one or more processors, wherein execution of the computer executable instructions by the one or more processors configure the computer implemented system to perform the method of claim 1.
